(19) United States
(12) Patent Application Publication
(10) Pub. No.: US 2025/0317587 A1
(43) Pub. Date: Oct. 9, 2025

(54) PURPOSE BUILT VEHICLE FOR TRANSMITTING VIDEO DATA AND OPERATION METHOD THEREOF

(71) Applicant: Seoul Dynamics, Gyeonggi-do (KR)

(72) Inventor: Yongseung Lee, Gyeonggi-do (KR)

(21) Appl. No.: 19/007,187

(22) Filed: Dec. 31, 2024

(30) Foreign Application Priority Data
Apr. 9, 2024 (KR) 10-2024-0047942

(51) Int. Cl. H04N 19/436; H04N 19/119; H04N 19/176

(52) U.S. Cl. CPC H04N 19/436; H04N 19/119; H04N 19/176

(57) ABSTRACT

A purpose-built vehicle device includes a communication unit, a sensor unit including at least one camera, and at least one processor electrically connected to the communication unit and the sensor unit. The at least one processor acquires video data over a first period of time through the sensor unit, identifies a plurality of sub-video data including at least part of the video data at the same time as acquiring the video data, in response to identifying the plurality of sub-video data performs parallel encoding for each of the plurality of sub-video data to acquire a plurality of pieces of encoded data, and in response to acquiring the plurality of pieces of encoded data, transmits each of the plurality of pieces of encoded data to a base station communicating with the purpose-built vehicle through the communication unit.

### CROSS-REFERENCE TO RELATED APPLICATIONS

The present application claims under 35 U.S.C. § 119(a) the benefit of Korean Patent Application Number 10-2024-0047942 filed Apr. 9, 2024, the entire contents of which application is incorporated herein for all purposes by this reference

### TECHNICAL FIELD

The embodiments disclosed in this disclosure relate to a purpose-built vehicle for transmitting video data and to a method of operating the same.

### BACKGROUND

A purpose-built vehicle (PBV) refers to a mobility device that is designed or manufactured for a special purpose and that can travel based on autonomous driving or remote driving. A purpose-built vehicle can be optimized to perform special tasks or functions depending on the purpose and can be used in various fields such as transportation, logistics delivery, construction, and ports. A purpose-built vehicle needs to adapt to diverse environments and situations; for this, the vehicle can collect and analyze various data to perform learning.

### SUMMARY

Along with autonomous driving, a purpose-built vehicle (PBV) can be controlled remotely from a control device. A purpose-built vehicle can be remotely controlled from the control device to travel on roads by using a wireless communication network infrastructure. For example, even in a region far away from the control device, the purpose-built vehicle can receive remote control signals via a base station (BS). The purpose-built vehicle can transmit video data about its driving environment to the control device, and the control device can generate and transmit control signals for controlling the vehicle based on the video data received from the purpose-built vehicle.

Based on the discussion above, the present disclosure provides an apparatus and method by which the purpose-built vehicle can transmit video data to the control device in a way that minimizes latency.

According to an embodiment of the present disclosure, a purpose-built vehicle device includes a communication unit, a sensor unit comprising at least one camera, and at least one processor electrically connected to the communication unit and the sensor unit. The at least one processor can: acquire video data over a first period of time through the sensor unit; identify a plurality of sub-video data, at least partially including the video data, at the same time as acquiring the video data; in response to the identification of the plurality of sub-video data, perform parallel encoding for each of the plurality of sub-video data to acquire a plurality of pieces of encoded data; and in response to acquiring the plurality of pieces of encoded data, transmit each of the plurality of encoded data to a base station communicating with the purpose-built vehicle through the communication unit.

In some embodiments, the first period of time may correspond to the internal control cycle of the device.

In some embodiments, based on the second period of time and the internal control cycle of the purpose-built vehicle, the at least one processor may receive a remote-control signal.

In some embodiments, the number of the plurality of sub-video data is determined based on a second period of time corresponding to the network latency, and the second period of time can be identified based on a reference signal received from the base station.

In some embodiments, based on the network latency, the at least one processor may generate encoding setting information, perform parallel encoding for the plurality of sub-video data based on the encoding setting information, and the encoding setting information may include the resolution, bitrate, and frame rate.

In some embodiments, the at least one processor may, based on the plurality of pieces of encoded data, generate one or more transmission packets, transmit the one or more transmission packets to the base station, and in response to receiving at least one NACK (non-acknowledgement) for the transmitted one or more transmission packets, update the number of the plurality of sub-video data.

In some embodiments, if it is identified that the strength of a signal received from the base station is equal to or less than a predetermined value, the at least one processor may be configured to update the number of the plurality of sub-video data.

In some embodiments, the reference signal may include at least one of a CSI-RS (channel state reference signal), an SSB (synchronization signal block), an SIB (system information block), or a PBCH (physical broadcast channel).

In some embodiments, the at least one processor may be configured to divide the entire frame region of the video data into multiple regions, and the plurality of sub-video data may include data pertaining to those multiple regions.

In some embodiments, the at least one processor may be configured to encode the plurality of sub-video data simultaneously.

According to another embodiment of the present disclosure, the operating method of a purpose-built vehicle includes: acquiring video data over a first period of time; at the same time as acquiring the video data, identifying a plurality of sub-video data that includes at least part of the video data; in response to identifying the plurality of sub-video data, performing parallel encoding for each of the plurality of sub-video data to acquire a plurality of pieces of encoded data; and in response to acquiring the plurality of pieces of encoded data, transmitting each of the plurality of pieces of encoded data to a base station that communicates with the purpose-built vehicle through the communication unit.

In some embodiments, the first period of time may correspond to the internal control cycle of the device.

In some embodiments, the operating method of the purpose-built vehicle may include receiving a remote-control signal based on the second period of time and the internal control cycle of the purpose-built vehicle.

In some embodiments, the number of the plurality of sub-video data is determined based on a second period of time corresponding to network latency, and the second period of time can be identified based on a reference signal received from the base station.

In some embodiments, the operating method of the purpose-built vehicle may include generating encoding setting information based on the network latency, and performing parallel encoding for the plurality of sub-video data based on the encoding setting information, and the encoding setting information may include resolution, bitrate, and frame rate.

In some embodiments, a method of operating a purpose-built vehicle includes acquiring video data over a first period of time through a sensor unit that has at least one camera. At the same time as acquiring the video data, the method includes identifying a plurality of sub-video data that include at least part of the video data. In response to identifying the plurality of sub-video data, the method includes performing parallel encoding for each of the plurality of sub-video data to acquire a plurality of pieces of encoded data. In response to acquiring the plurality of pieces of encoded data, the method includes transmitting each of the plurality of pieces of encoded data to a base station communicating with the purpose-built vehicle through a communication unit.

The method may further comprise updating the number of the plurality of sub-video data in response to receiving at least one NACK for one or more transmission packets corresponding to the transmitted plurality of pieces of encoded data. The method may include determining the number of the plurality of sub-video data based on a second period of time corresponding to network latency, where the second period of time is identified based on a reference signal received from the base station. The first period of time may correspond to an internal control cycle of the device. The method may further comprise generating encoding setting information based on network latency, where the encoding setting information includes resolution, bitrate, and frame rate, and performing parallel encoding for the plurality of sub-video data based on the generated encoding setting information.

The embodiments of the present disclosure offer the effect of minimizing latency between the purpose-built vehicle and the control device. Moreover, it provides the effect of enabling an adaptive determination of the video data encoding method according to network conditions.

The effects that can be obtained from the present disclosure are not limited to those mentioned in various embodiments, and other effects not mentioned will be clearly understood by those skilled in the art from the descriptions below.

### BRIEF DESCRIPTION OF THE DRAWINGS

FIG. 1 illustrates an example of a driving environment of a purpose-built vehicle according to one embodiment.

FIG. 2 illustrates a block configuration of a purpose-built vehicle according to one embodiment.

FIG. 3 illustrates a block configuration of a base station according to one embodiment.

FIG. 4 illustrates a block configuration of a control device according to one embodiment.

FIG. 5 illustrates the operation flow of a purpose-built vehicle according to one embodiment.

FIG. 6 illustrates an example of video data transmission by a purpose-built vehicle according to one embodiment.

FIG. 7 illustrates an example of synchronization of the purpose-built vehicle's internal control cycle, network latency, and remote-control cycle according to one embodiment.

FIG. 8 illustrates a signaling flow among a purpose-built vehicle, a base station, and a control device according to one embodiment.

In relation to the drawings, the same or similar reference numerals may be used for the same or similar components.

### DETAILED DESCRIPTION OF SPECIFIC EMBODIMENTS

Hereinafter, embodiments of the present disclosure will be described in detail with reference to the drawings so that those skilled in the art can easily implement them. However, the present disclosure may be implemented in various different forms and is not limited to the embodiments described herein. In the descriptions of the drawings, the same or similar reference numerals may be used for the same or similar components. Moreover, well-known functions and configurations may be omitted to ensure clarity and brevity.

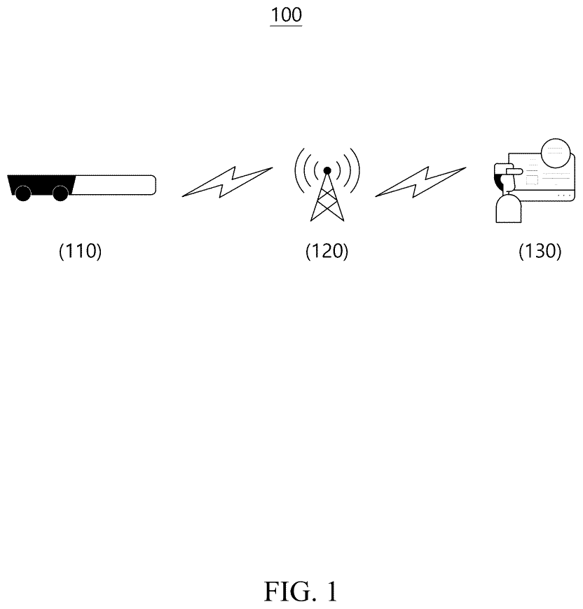

FIG. 1 illustrates an example of a driving environment of a purpose-built vehicle according to one embodiment. FIG. 1 shows, as part of nodes that use a wireless channel in a driving environment, a purpose-built vehicle (110), a base station (120), and a control device (130). Although FIG. 1 shows only one base station, one purpose-built vehicle, and one control device, other devices identical or similar to the purpose-built vehicle (110), base station (120), or control device (130) may also be included.

According to one embodiment, the driving environment (100) of the purpose-built vehicle may include the purpose-built vehicle (110), the base station (120), and the control device (130).

In some embodiments, the purpose-built vehicle (110) is a device capable of autonomous driving and remote driving by a user and can communicate with the base station (120) over a wireless channel. The purpose-built vehicle (110) can operate without user involvement, i.e., it may include a device performing machine-type communication (MTC). The purpose-built vehicle (110) can also be called an autonomous driving device, a remote driving device, or by another term that has an equivalent technical meaning. The purpose-built vehicle (110) can perform various functions by connecting to various types of task modules.

In some embodiments, the base station (120) is network infrastructure that provides wireless access to the purpose-built vehicle (110). The base station (120) has coverage that is defined as a certain geographic area based on the distance at which it can transmit signals. Besides “base station,” (BS), it may also be referred to by another term with an equivalent technical meaning, such as “access point (AP),” “eNodeB (eNB),” “5G node,” “wireless point,” or “transmission/reception point (TRP).”

In some embodiments, the control device (130) can be a control device for controlling the purpose-built vehicle (110). The control device (130) may be referred to as a “control device” or a “control server.”

In some embodiments, the base station (120) and the purpose-built vehicle (110) may transmit and receive wireless signals in the millimeter-wave (mmWave) band (e.g., 28 GHz, 30 GHz, 38 GHz, or 60 GHz). In that case, to improve channel gain, the base station (120) and the purpose-built vehicle (110) may perform beamforming. Here, beamforming can include both transmit beamforming and receive beamforming. That is, the base station (120) and the purpose-built vehicle (110) can provide directivity to the transmitted or received signals. To do so, the base station (120) and the purpose-built vehicle (110) can select serving beams 112, 113, 121, 131 via a beam search or beam management procedure. After the serving beams 112, 113, 121, 131 are selected, subsequent communications can be performed through resources that have a quasi-co-located (QCL) relationship with the resources that transmitted these serving beams 112, 113, 121, 131.

In some embodiments, if large-scale characteristics of a channel that delivered a symbol on a first antenna port can be inferred from a channel that delivered a symbol on a second antenna port, the first antenna port and the second antenna port can be deemed to be in a QCL relationship. For example, large-scale characteristics may include at least one of delay spread, Doppler spread, Doppler shift, average gain, average delay, or spatial receiver parameters.

In some embodiments, the purpose-built vehicle (110) can be controlled by a remote-control signal received from the control device (130). In the description below, when the control device (130) receives data from the purpose-built vehicle (110), or when the control device (130) transmits data to the purpose-built vehicle (110), such tasks can be performed via the base station (120). In other words, the purpose-built vehicle (110) can transmit data to the base station (120), and the base station (120), after receiving the data from the purpose-built vehicle (110), can transmit the data to the control device (130). The control device (130) can transmit data to the base station (120), and the base station (120) can transmit the data received from the control device (130) to the purpose-built vehicle (110). In the following description, transmitting or receiving data between the control device (130) and the purpose-built vehicle (110) can be understood to include data communication via the base station (120).

In some embodiments, the purpose-built vehicle (110) can transmit to the control device (130) data related to its driving. Such data can include video data acquired through the camera of the purpose-built vehicle (110), information about the speed of the vehicle, steering status, and so forth.

In some embodiments, the control device (130) can receive video data relating to the driving of the purpose-built vehicle (110) from the purpose-built vehicle (110).

In some embodiments, the control device (130) can decode the video data received from the purpose-built vehicle (110) and display it via the display of the control device (130).

In some embodiments, the control device (130) can transmit to the purpose-built vehicle (110) the data needed for the vehicle's driving. For example, the control device (130) can transmit data for remote driving to the purpose-built vehicle (110). For instance, the control device (130) can transmit to the purpose-built vehicle (110) information about other purpose-built vehicles driving collaboratively. For example, the control device (130) can transmit operational information needed for the driving of the purpose-built vehicle (110)—e.g., the specifications of the purpose-built vehicle (110), the specifications of the task module connected to the purpose-built vehicle (110), information about the region in which the purpose-built vehicle (110) is traveling, etc.

In some embodiments, the control device (130) can receive driving-related data from the purpose-built vehicle (110). For example, the control device (130) can receive driving data (e.g., driving time, driving speed, driving distance, driving route, driving environment, output of the purpose-built vehicle (110), etc.) from the purpose-built vehicle (110). For instance, the control device (130) can receive data from the purpose-built vehicle (110) that the purpose-built vehicle (110) acquired from other vehicles (e.g., another purpose-built vehicle engaged in collaborative driving, or other vehicles on the road).

In some embodiments, the control device (130) can, based on the driving-related data received from the purpose-built vehicle (110), train multiple autonomous driving models needed for the vehicle's driving. The number of autonomous driving models may be plural, depending on the vehicle's driving environment and the types of connected task modules. The control device (130) can perform training for each autonomous driving model.

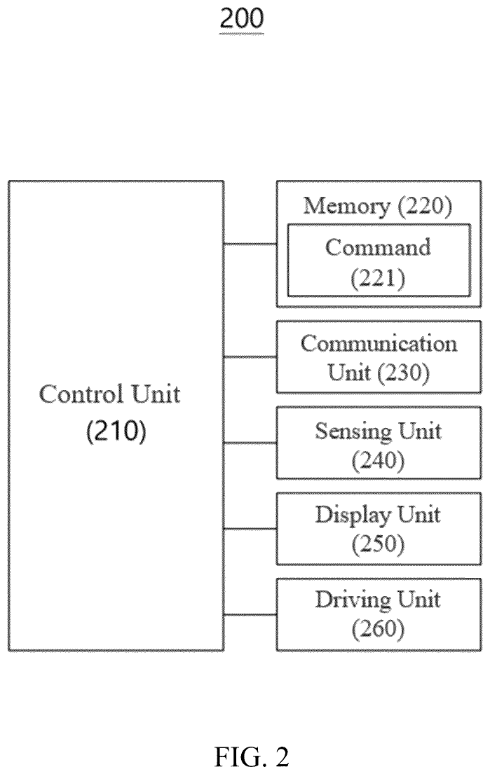

FIG. 2 illustrates the block configuration of the purpose-built vehicle according to one embodiment.

According to one embodiment, the purpose-built vehicle (110) may include a control unit (210), a memory (220), a communication unit (230), a sensing unit (240), a display unit (250), and a driving unit (260).

According to one embodiment, the memory (220) is a storage medium used by the purpose-built vehicle (110) and can store data, such as at least one command (221) corresponding to at least one program or setting information. The program can include an operating system (OS) and various application programs.

In some embodiments, the memory (220) can store data received from an external electronic device (for example, another purpose-built vehicle) that is located near the purpose-built vehicle (110). For example, data received from the external electronic device can include information about a task module, information about the work environment, etc.

In some embodiments, the memory (220) can include at least one type of storage medium, such as a flash memory type, hard disk type, multimedia card micro type, memory of a card type (e.g., SD or XD memory), RAM (random access memory), SRAM (static random access memory), ROM (read only memory), EEPROM (electrically erasable programmable ROM), PROM (programmable ROM), magnetic memory, magnetic disk, or optical disk.

According to one embodiment, the communication unit (230) can provide a wired or wireless communication interface that enables communication with external devices (e.g., other vehicles, control devices, relay devices, etc.).

In some embodiments, the communication unit (230) can include at least one of a wireless LAN communication unit and a short-range wireless communication unit. For example, the wireless LAN communication unit can include Wi-Fi, supporting the IEEE802.11x standard of the Institute of Electrical and Electronics Engineers (IEEE).

In some embodiments, under the control of the control unit (210), the communication unit (230) can wirelessly connect to an AP (Access Point). The AP is a device in a computer network that allows devices to connect using Wi-Fi-related standards. For instance, the relay device (130) can function as an AP.

In some embodiments, under the control of the control unit (210), the communication unit (230) can wirelessly perform short-range communication with an external device. Short-range communication can include Bluetooth, Bluetooth Low Energy, infrared communication (IrDA: Infrared Data Association), UWB (Ultra WideBand), and NFC (Near Field Communication). The external device can include a control device, another purpose-built vehicle, a relay device, or a user device (e.g., a smartphone or tablet PC).

In some embodiments, the control unit (210) can transmit, via the communication unit (230), data related to the driving of the purpose-built vehicle (110) to the control device (130). Such data can include video data acquired through the camera of the purpose-built vehicle (110), information about the speed of the vehicle, the steering status, and so forth.

In some embodiments, the control unit (210) can transmit, via the communication unit (230), video data acquired over a predetermined period of time to the control device (130). For example, the control unit (210) can transmit data about multiple frames acquired in 30 ms intervals to the control device (130) via the communication unit (230).

In some embodiments, the control unit (210) can transmit, via the communication unit (230), the video data acquired by the camera to the control device (130) on a frame-by-frame basis. For example, the purpose-built vehicle (110) can transmit it for every acquired frame to the control device (130).

In some embodiments, the control unit (210) can transmit video data to the control device (130) via the communication unit (230) in response to identifying a predetermined event. For example, if the control unit (210) determines that the purpose-built vehicle (110) needs remote control based on its driving environment (e.g., gradient, location, traffic status) and a user input, the control unit (210) can transmit video data to the control device (130) via the communication unit (230).

In some embodiments, the control unit (210) can perform encoding on the acquired video data. The encoding method can vary depending on the internal components (e.g., CPU or GPU) of the purpose-built vehicle (110), and can be determined in consideration of the network conditions.

According to one embodiment, by executing at least one command (221) stored in the memory (220), the control unit (210) can perform operations or data processing related to controlling and/or communication of at least one other component of the purpose-built vehicle (110).

In some embodiments, the control unit (210) may include at least one of a central processing unit (CPU), a graphics processing unit (GPU), an MCU (Micro Controller Unit), a sensor hub, a supplementary processor, a communication processor, an application processor, an ASIC (Application Specific Integrated Circuit), or an FPGA (Field Programmable Gate Array), and can have multiple cores.

In some embodiments, by executing software, the control unit (210) can control at least one other component (e.g., hardware or software) of the purpose-built vehicle (110) connected to the control unit (210) and can perform a variety of data processing or operations.

According to one embodiment, as at least part of the data processing or operations, the control unit (210) can store commands or data received from another component in a volatile memory, process the commands or data stored in the volatile memory, and store the resulting data in a non-volatile memory.

According to one embodiment, the control unit (210) can include a main controller (e.g., a central processing unit or application processor) or, independently or in conjunction with it, a supplementary controller (e.g., a graphics processing unit, an NPU (neural processing unit), an image signal controller, a sensor hub controller, or a communication controller). For example, if the purpose-built vehicle (110) includes both a main controller and a supplementary controller, the supplementary controller may consume lower power or be specialized in certain functions compared to the main controller. The supplementary controller can be implemented separately from, or as part of, the main controller.

In some embodiments, the sensing unit (240) can include various types of sensors used to detect objects adjacent to the purpose-built vehicle (110) and to identify the vehicle's status. For example, the purpose-built vehicle (110) can include one or more cameras, LiDAR sensors, IMU sensors, load sensors, proximity sensors, etc.

In some embodiments, the purpose-built vehicle (110) can acquire data about the surrounding environment (images or videos) via its cameras. By acquiring data about the surrounding environment (images or videos) through its cameras, for example, the purpose-built vehicle (110) can analyze images of the surrounding environment to identify objects (e.g., people, other vehicles, task modules, trailers) adjacent to the vehicle and, based on information about those identified objects, generate information about the vehicle's work environment. For instance, the purpose-built vehicle (110) can transmit the images of its driving, acquired via the camera, to the control device, and the control device can analyze them and send a signal for remote control of the purpose-built vehicle.

In some embodiments, the purpose-built vehicle (110) can use a proximity sensor to identify an object close to the vehicle (110). For instance, through the proximity sensor, the purpose-built vehicle (110) can detect the presence of other vehicles, pedestrians, animals, or objects located around the vehicle (110). For example, the purpose-built vehicle (110) can use the proximity sensor to identify the distance between the purpose-built vehicle (110) and a nearby object. This can allow the purpose-built vehicle (110) to avoid collisions with nearby objects, change lanes, and perform tasks. For example, the purpose-built vehicle (110) can identify the speed and direction of nearby objects through the proximity sensor. For instance, based on data acquired from the proximity sensor and other sensors in the sensing unit (240), the purpose-built vehicle (110) can create a 3D map of its surroundings.

In some embodiments, the purpose-built vehicle (110) can use a LiDAR (light detection and ranging) sensor to generate information about its surrounding environment. For example, the purpose-built vehicle (110) can identify the distance and location between nearby objects and the purpose-built vehicle (110) using the LiDAR sensor, and, based on data acquired from other sensors, create 3D environment map information. Additionally, for example, the purpose-built vehicle (110) can identify and classify nearby objects and track their speed and movement using the LiDAR sensor. Furthermore, for example, the purpose-built vehicle (110) can accurately recognize the driving and work environment (e.g., lanes, road boundaries, obstacles, etc.) of the purpose-built vehicle (110) via the LiDAR sensor.

In some embodiments, the purpose-built vehicle (110) can acquire data about its movement and direction via the IMU sensor. Through the IMU sensor, the purpose-built vehicle (110) can acquire information about linear acceleration, angular velocity, and the magnetic field for a task module, including an accelerometer, a gyroscope, or a magnetometer. For example, the purpose-built vehicle (110) can acquire information on speed changes (acceleration, deceleration) via the IMU sensor. For example, the purpose-built vehicle (110) can obtain information on the vehicle's angular velocity (change in direction, rotation, or tilt) via the IMU sensor. Based on the acceleration and angular velocity information acquired via the IMU sensor, the purpose-built vehicle (110) can generate information about the vehicle's current pose and tilt. The IMU sensor can be used in conjunction with GPS (global positioning system), not shown in the figure.

In some embodiments, the driving unit (260) can include configurations for controlling the movement of the purpose-built vehicle (110) and its task module. Through the driving unit (260), the purpose-built vehicle (110) can control its driving, direction, speed, and specific actions of the task module.

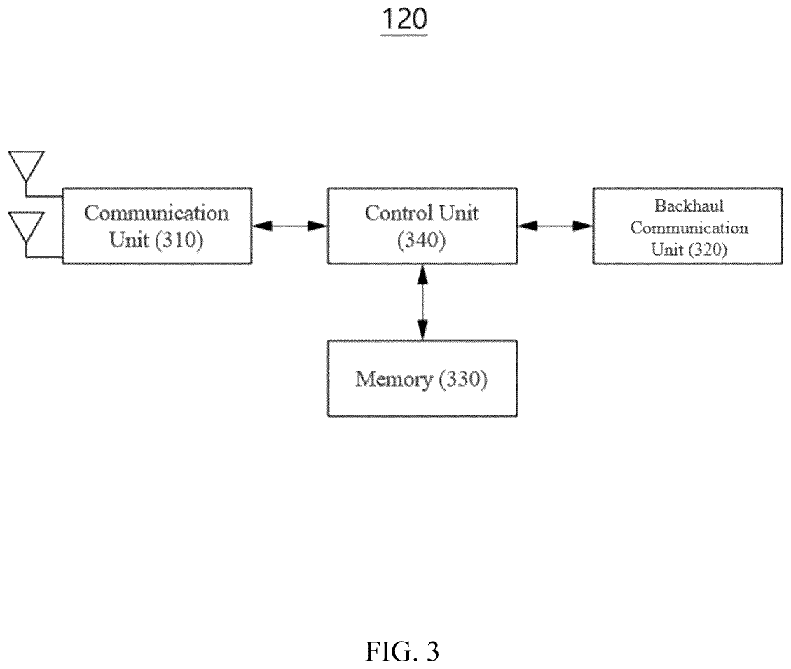

FIG. 3 illustrates the configuration of a base station in a wireless communication system according to various embodiments of the present disclosure. The configuration shown in FIG. 3 may be understood as the configuration of the base station (120). In what follows, the terms “unit,” “device,” etc. each refer to a unit that processes at least one function or operation, and can be implemented by hardware, software, or a combination of hardware and software.

Referring to FIG. 3, the base station can include a wireless communication unit (310), a backhaul communication unit (320), a memory (330), and a control unit (340).

In some embodiments, the wireless communication unit (310) can perform functions for transmitting and receiving signals over a wireless channel. For example, the wireless communication unit (310) can perform conversion functions between the baseband signal and a bit stream according to the physical layer specification of the system. For instance, for data transmission, the wireless communication unit (310) can generate complex symbols by encoding and modulating the transmit bit sequence. Additionally, for data reception, the wireless communication unit (310) can restore the received bit sequence by demodulating and decoding the baseband signal.

In some embodiments, the wireless communication unit (310) can up-convert a baseband signal to an RF (radio frequency) band signal and transmit it through an antenna and can down-convert an RF band signal received through an antenna into a baseband signal. To do so, the wireless communication unit (310) may include a transmit filter, a receive filter, an amplifier, a mixer, an oscillator, a DAC (digital-to-analog converter), or an ADC (analog-to-digital converter). The wireless communication unit (310) may also include multiple transmit and receive paths. Furthermore, the wireless communication unit (310) can include at least one antenna array consisting of multiple antenna elements.

In some embodiments, in hardware terms, the wireless communication unit (310) can be composed of a digital unit (DU) and an analog unit (AU), and the analog unit can be composed of multiple sub-units depending on the operating power, operating frequency, etc. The digital unit can be implemented as at least one processor (e.g., a DSP).

In some embodiments, as described above, the wireless communication unit (310) transmits and receives signals, so some or all of the wireless communication unit (310) may be referred to as a “transmitter,” “receiver,” or “transceiver.” Furthermore, in the following description, transmission and reception over a wireless channel includes the processing described above by the wireless communication unit (310).

In some embodiments, the backhaul communication unit (320) can provide an interface for communicating with other nodes in the network. That is, the backhaul communication unit (320) can convert the bit stream transmitted from the base station to another node—for example, another access node, another base station, an upper node, a core network, or the control device (130)—into physical signals, and it can convert physical signals received from another node into bit streams.

In some embodiments, the memory (330) can store data such as the basic program, application programs, and setting information for operating the base station. The memory (330) can be composed of volatile memory, non-volatile memory, or a combination thereof. The memory (330) can provide stored data upon request of the control unit (340).

In some embodiments, the control unit (340) can control the overall operation of the base station. For example, the control unit (340) can transmit and receive signals via the wireless communication unit (310) or the backhaul communication unit (320). Also, the control unit (340) can write data to the memory (330) or read data therefrom. In addition, the control unit (340) can perform functions of a protocol stack required by communication standards. Depending on the implementation, the protocol stack may reside in the wireless communication unit (310). To that end, the control unit (340) may include at least one processor. Here, a channel estimation unit, a PF scheduling unit, a weight determination unit, a SINR estimation unit, or a beamforming vector determination unit may be an instruction or code set stored in the memory (330) and at least temporarily resident in (or part of the circuitry of) the control unit (340).

According to one embodiment, the base station (120) can mediate the signaling between the purpose-built vehicle (110) and the control device (130). In other words, the base station (120) can deliver data received from the purpose-built vehicle (110) to the control device (130) and can deliver data received from the control device (130) to the purpose-built vehicle (110).

Depending on various embodiments, the control unit (340) can estimate the channel for each terminal based on reference signals received from each purpose-built vehicle (110), and based on the estimated channel information, it can determine a matrix representing beamforming vectors for each terminal, reflecting scheduling and power allocation information.

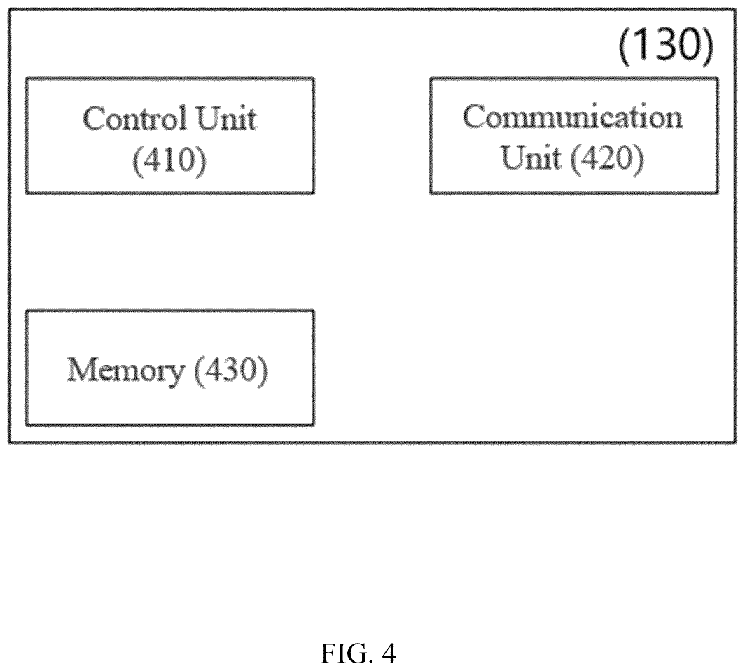

FIG. 4 illustrates the block configuration of a control device according to one embodiment.

According to one embodiment, the control device (130) includes a control unit (410), a memory (420), a communication unit (430), a display unit (440), and an input unit (450).

According to one embodiment, the memory (420) is a storage medium used by the purpose-built vehicle (110) and can store data such as at least one command (421) corresponding to at least one program or setting information. The program can include an operating system (OS) program and various application programs.

In some embodiments, the memory (420) can store data received from an external electronic device (e.g., another purpose-built vehicle) that is located near the purpose-built vehicle (110). For example, data received from the external electronic device can include information about a task module, information about the work environment, etc.

In some embodiments, the memory (420) may include at least one type of storage medium, such as a flash memory type, a hard disk type, a multimedia card micro type, a memory of a card type (e.g., SD or XD memory), RAM, SRAM, ROM, EEPROM, PROM, magnetic memory, a magnetic disk, or an optical disk.

According to one embodiment, the communication unit (430) can provide a wired or wireless communication interface that enables communication with external devices (e.g., other vehicles, control devices, base stations, etc.).

In some embodiments, the communication unit (430) may include at least one of a wired communication unit, a wireless LAN communication unit, or a short-range wireless communication unit. For example, the wireless LAN communication unit may include Wi-Fi, supporting the IEEE 802.11x standard of the Institute of Electrical and Electronics Engineers (IEEE).

In some embodiments, the control device (130) may be connected to the base station (120) by wire.

In some embodiments, under the control of the control unit (410), the communication unit (430) can wirelessly communicate with the purpose-built vehicle (110). The communication unit (430) can communicate with the purpose-built vehicle (110) through the base station (120).

In some embodiments, if the purpose-built vehicle (110) is located within a predetermined range of the control device (130), the control device (130) can perform short-range wireless communication with the vehicle (110). Short-range wireless communication can include Bluetooth, Bluetooth Low Energy, IrDA, UWB, NFC, etc. The external device may include a purpose-built vehicle, a relay device, or a user device (e.g., a smartphone, a tablet PC, etc.).

In some embodiments, the control device (130), via the communication unit (430), can receive (through the base station (120)) various kinds of data from the purpose-built vehicle (110), for example, driving data, information about the task modules connected to the purpose-built vehicle (110), information about the vehicle's surroundings, etc.

In some embodiments, the control device (130), via the communication unit (430), can transmit various kinds of data to the purpose-built vehicle (110), for example, information about the task module, information about the vehicle's driving route, an autonomous driving model, etc.

According to one embodiment, by executing at least one command (421) stored in the memory (420), the control unit (410) can perform operations or data processing related to controlling and/or communicating with at least one other component of the purpose-built vehicle (110).

In some embodiments, the control unit (410) may include at least one of a CPU, GPU, MCU, sensor hub, supplementary controller, communication controller, application controller, ASIC, or FPGA, and may have multiple cores.

In some embodiments, by executing software, the control unit (410) can control at least one other component (e.g., hardware or software) of the purpose-built vehicle (110) connected to the control unit (410) and can perform a variety of data processing or operations.

According to one embodiment, as at least part of data processing or operations, the control unit (410) can store in volatile memory commands or data received from another component, process the commands or data stored in the volatile memory, and store the resulting data in non-volatile memory.

According to one embodiment, the control unit (410) may include a main controller (e.g., a CPU or application controller) or, independently or in conjunction with it, a supplementary controller (e.g., a GPU, an NPU, an image signal controller, a sensor hub controller, or a communication controller). For example, if the purpose-built vehicle (110) includes both a main controller and a supplementary controller, the supplementary controller may be specialized in certain functions and consume less power than the main controller. The supplementary controller may be implemented separately from or as part of the main controller.

In some embodiments, the control unit (410) can decode video data received from the purpose-built vehicle (110). The control device (130) can display the decoded video data via the display unit (440).

According to one embodiment, the display unit (440) can perform functions for outputting information in the form of numbers, characters, images, and/or graphics. The display unit (440) can include at least one hardware module for output. For example, the hardware module can include at least one of an LCD, LED, LPD (light emitting polymer display), OLED, AMOLED, or FLED (flexible LED). The display unit (440) can display a screen corresponding to data received from the control unit (410). The display unit (440) can be referred to as an “output unit,” “display,” or another term with an equivalent technical meaning.

In some embodiments, the control device (130) can display on the display unit (440) information related to the operation of the purpose-built vehicle (110). For example, through the display unit (440), the control device (130) can display the driving route, speed, driving environment of the purpose-built vehicle (110), information about the task module, and information about the work environment.

In some embodiments, through the input unit (450), the purpose-built vehicle (110) can identify user input for controlling the control device (130) and the vehicle (110). For example, user input can include an input for adjusting the steering of the purpose-built vehicle (110), which is controlled by the control device (130). For instance, user input can include an input for adjusting the speed (e.g., pedal) of the purpose-built vehicle (110), which is controlled by the control device (130).

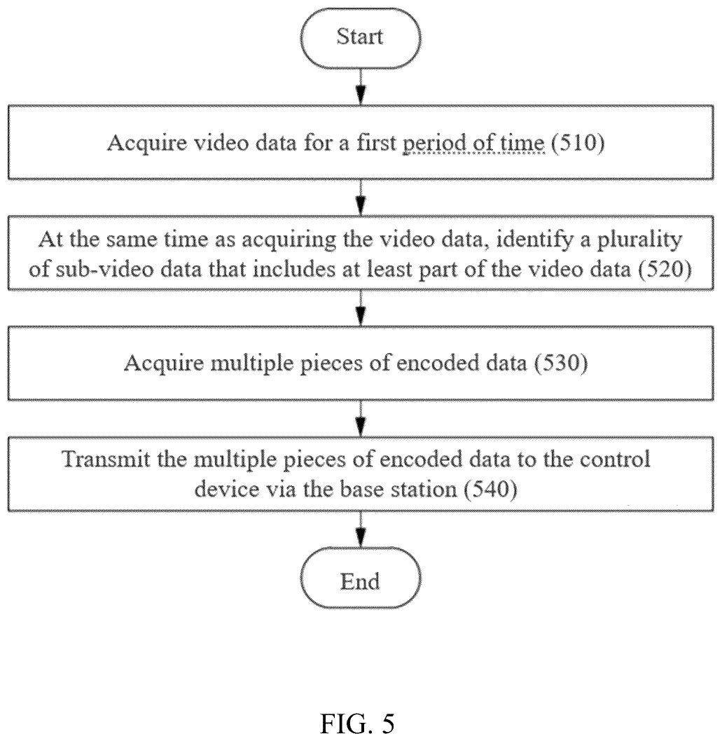

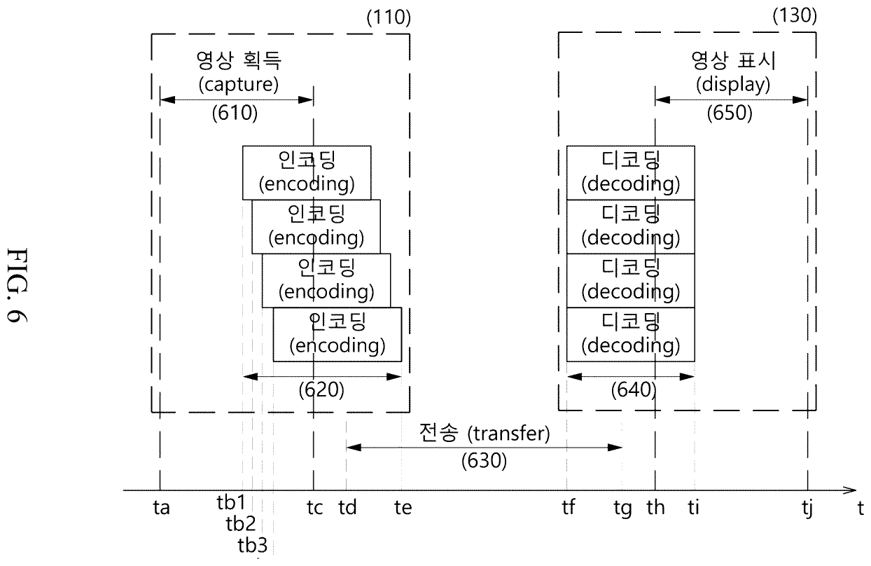

FIG. 5 illustrates the operation flow of a purpose-built vehicle according to one embodiment. FIG. 6 illustrates the flow of video data processing according to one embodiment. The purpose-built vehicle in FIG. 5 and FIG. 6 can include the device corresponding to the purpose-built vehicle (110) in FIGS. 1-4. The control device in FIG. 5 and FIG. 6 can include the device corresponding to the control device (130) in FIGS. 1-4. The base station in FIG. 5 and FIG. 6 can include the device corresponding to the base station (120) in FIGS. 1-4.

According to one embodiment, in operation 510, the purpose-built vehicle can acquire video data for a first period of time. The purpose-built vehicle can acquire video data about the surroundings of the vehicle in real time through the sensor unit (e.g., camera).

In some embodiments, the video data may include data for at least one frame acquired over the first period of time.

In some embodiments, the first period of time can have a length corresponding to the internal control cycle of the purpose-built vehicle. The internal control cycle can refer to a cycle for controlling the output of the motor in real time by adjusting electrical signals between the electric motor, motor drive, inverter, and power of an autonomous vehicle. The internal control cycle of the purpose-built vehicle can be determined by at least one timer's resolution available in the vehicle's PLC (programmable logic controller).

Referring to FIG. 6, in a first step (601), the purpose-built vehicle can acquire (or capture) surrounding images via a camera to obtain video data. The time during which the purpose-built vehicle acquires (or captures) video data may be referred to as the first time (ta-tb).

According to one embodiment, in operation 520, at the same time as acquiring the video data, the purpose-built vehicle can identify a plurality of sub-video data that includes at least part of the video data.

In some embodiments, while acquiring the video data, the purpose-built vehicle can perform preprocessing for encoding the video data. For example, during the process of performing preprocessing (e.g., resizing images, converting color spaces, adjusting frame rates, removing noise, etc.) in order to encode the video data at the same time as acquiring it, if the size of data identified exceeds a predetermined value, the purpose-built vehicle can determine that data to be one sub-video data.

In some embodiments, the plurality of sub-video data can be determined based on the type of channel used during the process of preprocessing the acquired video data.

In some embodiments, the purpose-built vehicle can divide the video data into a plurality of sub-video data. The sub-video data can include data obtained by dividing the video data according to predetermined criteria.

In some embodiments, if the video data includes multiple frames, the sub-video data can be created by dividing the video data every predetermined number of frames. For example, if the video data includes 8 frames, the purpose-built vehicle may divide the video data every 2 frames. As a result, a total of 4 sub-video data, each including 2 frames, can be acquired. For instance, if the video data includes 10 frames, the purpose-built vehicle may divide it every 5 frames, resulting in a total of 2 sub-video data, each consisting of 5 frames.

In some embodiments, the plurality of sub-video data can include the same number of frames, or they can include a different number of frames. In other words, the purpose-built vehicle may divide the video data so that each piece of sub-video data has the same length, or so that each has a different length (i.e., a different number of frames).

In some embodiments, the number of the plurality of sub-video data may be determined based on a second period of time (hereinafter called “the second time”), which corresponds to the network latency. For example, if the network latency exceeds a predetermined value, the purpose-built vehicle may decide to divide the video data into n (n: integer, n>0) sub-video data. If the network latency is equal to or less than the predetermined value, the purpose-built vehicle may decide to divide the video data into m (m: integer, n>m>0) sub-video data.

In some embodiments, the second period of time can refer to the time needed for signals to travel between the purpose-built vehicle and the control device.

In some embodiments, the second period of time can be identified based on a reference signal received by the purpose-built vehicle from the base station. For example, the reference signal can be at least one of a CRS (cell-reference signal), a CSI-RS (channel state indicator-reference signal), an SSB (synchronization signal block), an SIB (system information block), or a PBCH (physical broadcast channel).

In some embodiments, if the video data includes one frame, the purpose-built vehicle can divide the entire pixel region of that frame into multiple sub-pixel regions and identify the data corresponding to each region as sub-video data.

According to one embodiment, in operation 530, the purpose-built vehicle can acquire multiple pieces of encoded data. By performing parallel encoding on the multiple sub-video data obtained by dividing the video data, the purpose-built vehicle can obtain multiple pieces of encoded data.

In some embodiments, the purpose-built vehicle can perform encoding on the multiple sub-video data to obtain multiple sub-video data that are encoded.

In some embodiments, instead of sequentially encoding the multiple sub-video data, the purpose-built vehicle may perform parallel encoding on each piece of sub-video data as soon as it is identified.

For example, referring to FIG. 6, in a second step (620), while the purpose-built vehicle is performing preprocessing on the video data acquired in the first step (610), it can perform encoding immediately for each sub-video data identified. At time ta, one sub-video data can be identified, and encoding can be performed on it immediately. At time tb, another sub-video data can be identified, and encoding can be performed on it right away. (Likewise for additional sub-video data identified at subsequent times.) In other words, the vehicle could wait until preprocessing is complete on the entire video data, then divide it into multiple sub-video data, but if the vehicle finds that data has been preprocessed beyond a certain ratio, it can encode that data as soon as it is identified.

In some embodiments, the purpose-built vehicle can divide the video data into 4 sub-video data, then encode each sub-video data in parallel.

In some embodiments, the purpose-built vehicle can generate encoding setting information based on the second period of time and then perform parallel encoding on each of the multiple sub-video data based on the generated encoding setting information. The encoding setting information can include resolution, bitrate, frame rate, and so on.

According to one embodiment, in operation 540, the purpose-built vehicle can transmit the multiple pieces of encoded data to the control device via the base station.

In some embodiments, the purpose-built vehicle can individually transmit the multiple pieces of encoded data that were created to the base station, or it can generate multiple packets based on the multiple pieces of encoded data and transmit those generated packets to the base station.

Referring to FIG. 6, in a third step (630), the purpose-built vehicle (110) can transmit the encoded data to the control device (130) via a base station (e.g., base station (120)). td can refer to the time when the encoded data is transmitted in advance, tg can refer to the time when the transmission of all encoded data is complete, and te can refer to the time when encoding of the last sub-video data is finished.

In some embodiments, the purpose-built vehicle can generate one or more transmission packets based on the encoded data and transmit them to the base station. The purpose-built vehicle can receive an ACK (acknowledgement) or a NACK (non-acknowledgement) for the one or more transmission packets. If at least one NACK is received for at least one of the transmission packets, the purpose-built vehicle can update (e.g., decrease or increase) the number of the multiple sub-video data.

In some embodiments, if the strength of the reference signal (e.g., RSSI) received from the base station is equal to or less than a predetermined value, the purpose-built vehicle can update the number of the multiple sub-video data. In other words, if the strength of the reference signal is weak and the vehicle determines that it needs to adjust the encoding method, the purpose-built vehicle can update the number of the multiple sub-video data in order to change the division criteria.

Referring to FIG. 6, In some embodiments, in a fourth step (640), the control device (130) can decode the encoded sub-video data received from the purpose-built vehicle (110), and in a fifth step (650), it can display the video data via a display unit. tf can refer to the time when decoding of the received encoded data begins. Although not shown in the figure, tf might differ for each piece of encoded data (e.g., tf1, tf2, tf3, tf4). th can refer to the time when video display starts, and tj can refer to the time when display of the acquired video data is completed.

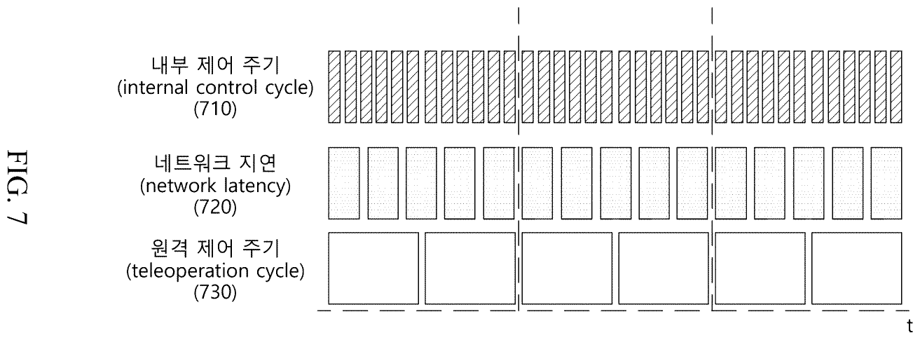

FIG. 7 illustrates an example of synchronizing the internal control cycle of a purpose-built vehicle, network latency, and a remote-control cycle according to one embodiment. The purpose-built vehicle in FIG. 7 can include the same device as the purpose-built vehicle (110) in FIGS. 1-6. In the description of FIG. 7, overlapping content with FIGS. 1-6 may be omitted.

Referring to FIG. 7, the purpose-built vehicle may consider three cycles in its operation.

In some embodiments, the internal control cycle (710) can refer to a cycle that controls the motor's output in near-real time by adjusting electrical signals among the electric motor, motor drive, inverter, and power in an autonomous driving vehicle. The internal control cycle of the purpose-built vehicle can be determined by at least one timer's resolution available in the vehicle's PLC.

In some embodiments, the network latency (720) can refer to the time required to transmit signals (e.g., control signals, video data, etc.) between the purpose-built vehicle and the control device via the network infrastructure (e.g., a base station). The network latency can vary depending on the throughput of the current base station, the channel conditions among the purpose-built vehicle, the base station, and the control device, the amount of traffic, and the performance of the purpose-built vehicle. For example, the network latency can be the time from ta to tj.

In some embodiments, the remote-control cycle (730) can refer to the cycle in which the control device transmits a remote-control signal to the purpose-built vehicle to control it. For example, it can refer to the minimum cycle at which a control command input by a controller operator through the control device's input unit (e.g., steering device, accelerator or brake pedal), together with messages collected from other sensors, is dispatched to the control device.

Referring to FIG. 7, these three cycles can each be set to different values. For instance, the internal control cycle may be set to 10 ms, the network latency might be measured at 140 ms, and the remote-control cycle might be set to 100 ms.

In some embodiments, the purpose-built vehicle can synchronize these three cycles to minimize data processing and command execution latency and optimize the vehicle's stability and responsiveness. In other words, the purpose-built vehicle can perform precise time synchronization among the vehicle's internal systems (e.g., video data capture and acquisition), the network, and the remote operation system. This can be implemented using technologies such as NTP (network time protocol).

In some embodiments, considering the synchronized three cycles, the purpose-built vehicle can carry out the capture of video data and transmission to the control device. For example, the purpose-built vehicle can adjust time (e.g., ta, tb, tc) as a changeable parameter so as to adaptively synchronize the internal control cycle, network latency, and remote-control cycle.

In some embodiments, to adjust ta, tb, tc, the purpose-built vehicle may determine conditions for acquiring sub-video data from the video data. For example, it can adjust the size of the data that one sub-video data should contain, thereby adjusting ta, tb, tc.

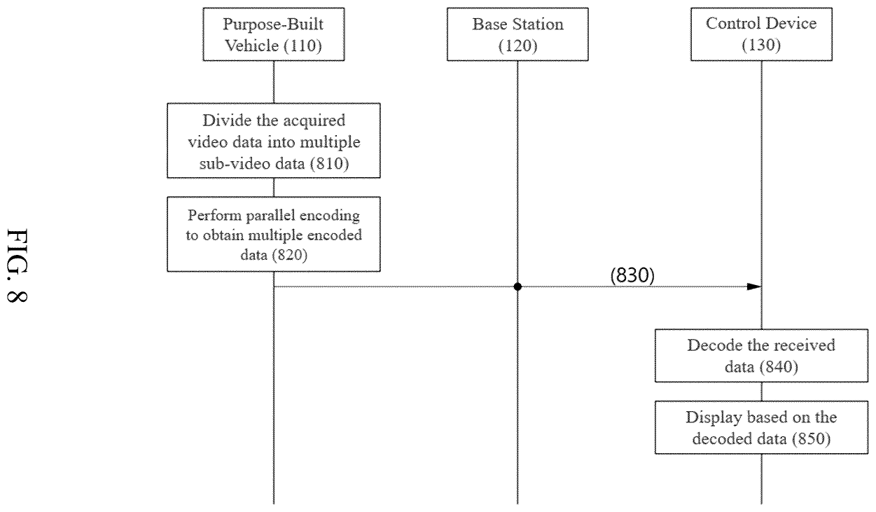

FIG. 8 illustrates a signaling flow among the purpose-built vehicle, the base station, and the control device according to one embodiment. In the description of FIG. 8, any overlapping content with FIGS. 1-7 may be omitted.

According to one embodiment, in operation 810, the purpose-built vehicle (110) can divide the acquired video data into multiple sub-video data. Operation 810 can include the details of operation 510 and operation 520 of FIG. 5.

According to one embodiment, in operation 810, the purpose-built vehicle (110) can divide the acquired video data into multiple sub-video data. Operation 810 can include the details of operation 510, operation 520 in FIG. 5, and step (610) in FIG. 6.

According to one embodiment, in operation 820, the purpose-built vehicle (110) can perform parallel encoding on the multiple sub-video data to obtain multiple encoded data. Operation 820 can include the details of operation 530 in FIG. 5 and step (620) in FIG. 6.

According to one embodiment, in operation 830, the purpose-built vehicle (110) can transmit the encoded data to the control device (130). Operation 830 can include the details of operation 540 in FIG. 5 and step (630) in FIG. 6.

In some embodiments, the purpose-built vehicle (110) transmits the encoded data to the base station (120), and the base station (120) forwards that data to the control device (130).

According to one embodiment, in operation 840, the control device (130) can decode the received data. Operation 840 can include the details of step (640) in FIG. 6.

According to one embodiment, in operation 850, the control device (130) can display on its display unit the video based on the decoded data. Operation 850 can include the details of step (650) in FIG. 6.

According to one embodiment of the present disclosure, a purpose-built vehicle can include a communication unit, a sensor unit including at least one camera, and at least one processor electrically connected to the communication unit and the sensor unit. The at least one processor can: acquire video data over a first period of time through the sensor unit; divide the video data into multiple sub-video data; perform parallel encoding on the multiple sub-video data to obtain multiple encoded data; and transmit the multiple encoded data to a base station communicating with the vehicle via the communication unit. The number of the multiple sub-video data is determined based on a second period of time that corresponds to network latency, and the second period of time can be identified based on a reference signal received from the base station.

In some embodiments, the first period of time may correspond to the internal control cycle of the purpose-built vehicle.

In some embodiments, the at least one processor can be configured to receive a remote-control signal based on the second period of time and the internal control cycle of the purpose-built vehicle.

In some embodiments, the multiple sub-video data can each include the same number of frames.

In some embodiments, based on the network latency, the at least one processor can generate encoding setting information and based on that information, perform parallel encoding on the multiple sub-video data. The encoding setting information may include resolution, bitrate, and frame rate.

In some embodiments, the at least one processor can generate one or more transmission packets based on the multiple encoded data, transmit the one or more transmission packets to the base station, and in response to receiving at least one NACK (non-acknowledgement) for the transmitted one or more transmission packets, update the number of the multiple sub-video data.

In some embodiments, if the strength of a signal received from the base station is determined to be below a predetermined value, the at least one processor may be configured to update the number of the multiple sub-video data.

In some embodiments, the reference signal can be at least one of CSI-RS (channel state reference signal), SSB (synchronization signal block), SIB (system information block), or PBCH (physical broadcast channel).

In some embodiments, the at least one processor can divide the entire frame region of the video data into multiple regions, and the multiple sub-video data may include data for these multiple regions.

In some embodiments, the at least one processor can be configured to encode the multiple sub-video data simultaneously.

According to another embodiment of the present disclosure, the operating method of a purpose-built vehicle includes: acquiring video data over a first period of time, dividing the video data into multiple sub-video data, performing parallel encoding on the multiple sub-video data to obtain multiple encoded data, and transmitting the multiple encoded data to a base station communicating with the purpose-built vehicle via the communication unit. The number of the multiple sub-video data is determined based on a second period of time corresponding to network latency, and the second period of time can be identified based on a reference signal received from the base station.

In some embodiments, the first period of time may correspond to the internal control cycle of the purpose-built vehicle.

In some embodiments, the operating method of the purpose-built vehicle may include receiving a remote-control signal based on the second period of time and the internal control cycle of the purpose-built vehicle.

In some embodiments, the multiple sub-video data can each include the same number of frames.

In some embodiments, the operating method of the purpose-built vehicle may include generating encoding setting information based on the network latency, and performing parallel encoding on the multiple sub-video data based on that encoding setting information, where the encoding setting information can include resolution, bitrate, and frame rate.

Various electronic devices according to the embodiments disclosed herein can take various forms. For example, an electronic device can include a display device, a portable communication device (e.g., a smartphone), a computer device, a portable multimedia device, a portable medical device, a camera, a wearable device, or a home appliance. The electronic device according to the embodiments described herein is not limited to the aforementioned devices.

The various embodiments and the terms used therein do not limit the technical features disclosed herein to specific embodiments; rather, they should be understood to include modifications, equivalents, or alternatives. For example, a component expressed in the singular should be understood to include multiple components unless it is clearly stated to refer to a single component only. The term “and/or” should be understood to encompass every possible combination of one or more of the listed items. The terms “include,” “have,” and “comprise,” as used herein, simply designate the presence of the features, components, or parts (or combinations thereof) described, and do not exclude the possibility of adding one or more other features, components, parts (or combinations thereof). The phrases “A or B,” “at least one of A or B,” “at least one of A or B,” “A, B, or C,” “at least one of A, B, or C,” and “at least one of A, B, or C” should be understood to include any combination of one or more of the listed items. The terms “first,” “second,” “primary,” or “secondary,” etc. may be used simply to distinguish one component from another component having the same name, rather than limiting the importance or order of those components.

In the various embodiments of this disclosure, the terms “unit” or “module” can include hardware, software, or firmware implementations, e.g., logic, a logic block, a component, or a circuit, and can be used interchangeably. A “unit” or “module” can be an integrated part or can be the smallest unit or part that performs one or more functions. For instance, according to one embodiment, a “unit” or “module” can be implemented in the form of an ASIC (application-specific integrated circuit).

In the various embodiments of this disclosure, the expression “in the event ˜” can be interpreted based on the context as “when ˜,” “if ˜,” or “in response to determining ˜” or “in response to detecting ˜.” Similarly, “in the event ˜ is determined” or “in the event ˜ is detected” can be interpreted, according to the context, as “when determination is made” or “in response to making a determination,” or as “when detection is made” or “in response to detecting.”

A program executed by a device described in this disclosure can be implemented with hardware components, software components, and/or a combination thereof. A program can be executed by any system capable of executing computer-readable instructions.

Software can include a computer program, code, instructions, or any combination thereof, configuring a processing device to operate as desired or instructing the processing device (collectively, independently or in combination) to operate. Software can be implemented as a computer program containing instructions stored in a computer-readable storage medium. Examples of a computer-readable storage medium include magnetic storage media (e.g., ROM, RAM, a floppy disk, a hard disk, etc.) and optical reading media (e.g., a CD-ROM, a DVD). A computer-readable storage medium can be distributed across computer systems connected by a network, enabling code to be stored or executed in a distributed fashion. A computer program can be distributed online (e.g., downloaded or uploaded) via, for example, an application store (e.g., Play Store™) or directly between two user devices (e.g., smartphones). In the case of online distribution, at least part of the computer program product may be temporarily stored or temporarily generated in a computer-readable storage medium, such as the memory of the manufacturer's server, the memory of the application store's server, or the memory of an intermediary server.

According to various embodiments, each of the components (e.g., modules or programs) of the above-described configurations can include single or multiple entities, and some of the multiple entities may be placed separately from other components. According to various embodiments, one or more of the components or operations described above may be omitted, or one or more other components or operations may be added. Alternatively or additionally, multiple components (e.g., modules or programs) may be integrated into one component. In such a case, the integrated component can perform the same or similar functions of the multiple components, each of which would have been performed by the separate components prior to integration. According to various embodiments, operations performed by modules, programs, or other components can be executed sequentially, in parallel, repeatedly, or heuristically; or one or more of these operations can be performed in a different order, be omitted, or be supplemented by one or more other operations.

What is claimed is:

1. A purpose-built vehicle device comprising:
a communication unit;
a sensor unit including at least one camera; and
at least one processor electrically connected to the communication unit and the sensor unit, wherein the at least one processor:
acquires video data over a first period of time through the sensor unit;
at the same time as acquiring the video data, identifies a plurality of sub-video data including at least part of the video data;
in response to identifying the plurality of sub-video data, performs parallel encoding for each of the plurality of sub-video data to acquire a plurality of pieces of encoded data;
and
in response to acquiring the plurality of pieces of encoded data, transmits each of the plurality of pieces of encoded data to a base station communicating with the purpose-built vehicle device through a communication unit.

2. The device of claim 1, wherein the first period of time corresponds to an internal control cycle of the device.

3. The device of claim 2, wherein the at least one processor is configured to receive a remote-control signal based on a second period of time corresponding to network latency, and the internal control cycle of the purpose-built vehicle device.

4. The device of claim 1, wherein the number of the plurality of sub-video data is determined based on a second period of time corresponding to network latency, and the second period of time is identified based on a reference signal received from the base station.

5. The device of claim 1, wherein the at least one processor:
generates encoding setting information based on network latency; and
performs parallel encoding for the plurality of sub-video data based on the encoding setting information, and
wherein the encoding setting information includes resolution, bitrate, and frame rate.

6. The device of claim 1, wherein the at least one processor:
generates one or more transmission packets based on the plurality of pieces of encoded data;
transmits the one or more transmission packets to the base station; and
in response to receiving at least one NACK (non-acknowledgement) for the transmitted one or more transmission packets, updates the number of the plurality of sub-video data.

7. The device of claim 1, wherein, if the at least one processor identifies that the strength of the signal received from the base station is at or below a predetermined value, the at least one processor updates the number of the plurality of sub-video data.

8. The device of claim 4, wherein the reference signal includes at least one of CSI-RS (channel state reference signal), SSB (synchronization signal block), SIB (system information block), or PBCH (physical broadcast channel).

9. The device of claim 1, wherein the at least one processor is configured to divide the entire frame region of the video data into multiple regions, and the plurality of sub-video data includes data for those multiple regions.

10. The device of claim 1, wherein the at least one processor is configured to encode the plurality of sub-video data simultaneously.

11. A method of operating a purpose-built vehicle device comprising:
acquiring video data over a first period of time;
at the same time as acquiring the video data, identifying a plurality of sub-video data that includes at least part of the video data;
in response to identifying the plurality of sub-video data, performing parallel encoding for each of the plurality of sub-video data to acquire a plurality of pieces of encoded data; and
in response to acquiring the plurality of pieces of encoded data, transmitting each of the plurality of pieces of encoded data to a base station communicating with the purpose-built vehicle device through a communication unit.

12. The method of claim 11, wherein the first period of time corresponds to the internal control cycle of the device.

13. The method of claim 12, further comprising receiving a remote-control signal based on a second period of time corresponding to network latency, and the internal control cycle of the purpose-built vehicle device.

14. The method of claim 11, wherein the number of the plurality of sub-video data is determined based on a second period of time corresponding to network latency, and the second period of time is identified based on a reference signal received from the base station.

15. The method of claim 11, further comprising:
generating encoding setting information based on network latency; and
performing parallel encoding on the plurality of sub-video data based on the encoding setting information, and
wherein the encoding setting information includes resolution, bitrate, and frame rate.

16. A method of operating a purpose-built vehicle, the method comprising:
acquiring video data over a first period of time through a sensor unit including at least one camera;
at the same time as acquiring the video data, identifying a plurality of sub-video data including at least part of the video data;
in response to identifying the plurality of sub-video data, performing parallel encoding for each of the plurality of sub-video data to acquire a plurality of pieces of encoded data; and
in response to acquiring the plurality of pieces of encoded data, transmitting each of the plurality of pieces of encoded data to a base station communicating with the purpose-built vehicle through a communication unit.

17. The method of claim 16, further comprising:
in response to receiving at least one NACK (non-acknowledgement) for one or more transmission packets corresponding to the transmitted plurality of pieces of encoded data, updating the number of the plurality of sub-video data.

18. The method of claim 16, wherein the number of the plurality of sub-video data is determined based on a second period of time corresponding to network latency, and the second period of time is identified based on a reference signal received from the base station.

19. The method of claim 16, wherein the first period of time corresponds to an internal control cycle of the device.

20. The method of claim 16, further comprising:
generating encoding setting information based on the network latency, wherein the encoding setting information includes resolution, bitrate, and frame rate; and
performing parallel encoding for the plurality of sub-video data based on the generated encoding setting information.
